(19) United States
(12) Patent Application Publication
(10) Pub. No.: US 2015/0072862 A1
(43) Pub. Date: Mar. 12, 2015

(54) MULTILAYERED FILMS CAPABLE OF RELEASING ACTIVE INGREDIENTS OVER A LIMITED TIME PERIOD

(71) Applicants: BAYER INNOVATION GMBH, Leverkusen (DE); IMAFLEX INC., Montreal (CA)

(72) Inventors: Ralf Dujardin, Dusseldorf (DE); Jochen Norwig, Leverkusen (DE); Fadi El Cheikh Ali, Pierrefonds (CA); Gerry Phelps, Toronto (CA)

(73) Assignees: BAYER INNOVATION GMBH, Leverkusen (DE); IMAFLEX INC., Montreal, CA (US)

(21) Appl. No.: 14/388,428

(22) PCT Filed: Mar. 21, 2013
(86) PCT No.: PCT/EP2013/055946

§ 371 Date: Sep. 26, 2014

Related U.S. Application Data
(60) Provisional application No. 61/616,087, filed on Mar. 27, 2012.

(51) Int. Cl. A01N 25/34; A01N 43/40; A23L 3/3463; A01N 47/36; A23L 3/3598; B29D 7/01; A01N 43/50

(52) U.S. Cl. CPC A01N 25/34; B29D 7/01; A01N 43/40; A01N 43/50; A01N 47/36; A23L 3/3598; A23L 3/34635; B29L 2009/00
USPC 504/215; 264/510; 424/409; 514/357

(57) ABSTRACT

The present disclosure relates to a multilayer film capable of releasing an active ingredient, for example a pesticide. The film has a bottom or internal layer composed in part of a water-soluble polymer fraction containing the active ingredient, and a top or external layer. The bottom or internal layer may have a water-insoluble fraction in addition to the water-soluble polymer fraction. Relative proportions of the water-soluble polymer fraction and of the water-insoluble fraction provide a pre-determined time of release of the active ingredient when the multilayer film is exposed to humidity and/or moist conditions. The present disclosure also relates to methods of making the multilayer film and to uses of the film.

### TECHNICAL FIELD

The present disclosure relates to the field of films containing active ingredients. More specifically, the present disclosure relates to multilayered films capable of releasing active ingredients over a limited time period and to a process of making such films.

### BACKGROUND

Specialty crops are defined in law as “fruits and vegetables, tree nuts, dried fruits and horticulture and nursery crops, including floriculture”. The use of multilayered plastic mulch film predominately made of polyethylene to cover the soil for growing specialty crops has become widespread, as it advances and enhances cropping when temperatures are low, reduces water consumption and improves crop yield. Crops are seeded or transplanted through slits or holes punched in the film afterwards.

Multilayered tubular or closed bags made of polyethylene are frequently used to cultivate seedlings for transplanting, growing bags for vegetable and fruit production or as flexible containers for protection produce from contamination or deterioration during post-harvest storage, transport, processing and marketing.

In the present disclosure, the terms ‘active ingredient’ and ‘pesticide’ are used interchangeably. The term ‘pesticide’ should be understood as broadly defined in the International Code Of Conduct on the Distribution and Use of Pesticides, adopted by the Hundred and Twenty-third Session of the Food and Agriculture Organization of the United Nations (FAO) Council in November 2002:

Pesticide means any substance or mixture of substances intended for preventing, destroying or controlling any pest, including vectors of human or animal disease, unwanted species of plants or animals causing harm during or otherwise interfering with the production, processing, storage, transport or marketing of food, agricultural commodities, wood and wood products or animal feedstuffs, or substances which may be administered to animals for the control of insects, arachnids or other pests in or on their bodies. The term includes substances intended for use as a plant growth regulator, defoliant, desiccant or agent for thinning fruit or preventing the premature fall of fruit, and substances applied to crops either before or after harvest to protect the commodity from deterioration during storage and transport.

The type of plastic mulch film selected can exert a distinct effect on weed control. Transparent mulch does not prevent weeds from growing and, in fact, may make their growth more vigorous due to the greenhouse environment beneath the plastic. Black plastic mulch prevents light from reaching the soil surface, which in turn prevents most annual weeds, e.g. grasses from growing. But perennial weeds, e.g. yellow and purple nutsedge (Cyperus spp) growing from underground structures are capable of growing through black plastic mulch films. Therefore the soil is treated with post-emergence, translocated herbicides prior to or at the time of placing the film on the ground. For the control of soil borne disease, fungi and nematodes volatile, translocated pesticides—so called fumigants—are applied before laying the mulch films for disinfestations of the soil. Methyl bromide is the most effective fumigant but its use is now largely prohibited under the Montreal Protocol due to its ozone depleting properties. Alternative fumigants are lacking the broad spectrum pest control of Methyl Bromide, which is why they are combined with other pesticides to provide effective soil disinfestation. Soil disinfestation prior to laying the mulch films on the ground is an essential practice to give the plant a pest-free environment to mature.

The use of pesticides in these conditions can cause problems e.g., operator's exposure to spray applied pesticides or crop phytotoxicity by overdosing; not least a result of the need for application before the film has been laid. Incorporation of the pesticide into the film obviates both of these problems. The incorporation of pesticides in films and sheets—the difference between films and sheets is primarily the thickness—are known in the art. The terms “sheet” and “film” are used interchangeably in the present disclosure. It is also known in the art that the release of the pesticide has to occur predominantly on the underside to be transported away to the soil/crop and that pesticides can be incorporated into plastic films prior to their being formed.

Chinese Patent 1254502C disclose a process for making an herbicidal mulching sheet by premixing polyethylene with either Aetochloror Alachlor as herbicide, emulsifier, inorganic filler and plasticizer to form a master batch which is used directly to produce a mulching sheet by blow-molding. The master batch takes a granular form and is used directly in the blow extrusion process for making the film. Chinese Patent Application 1157689 (A) describes an herbicidal mulch film for agricultural use, in which a plastic resin is mixed with the two herbicides Alachlor and Metribuzin in a certain ratio until uniformity in a high-speed mixer. The resulting mixture is molten, and directly blow-extruded into an herbicidal mulch film. The skilled artisan will readily appreciate that the films described in the Chinese patent and patent application are monolayer films because of the direct use of the disclosed master batch for the manufacturing of the herbicidal mulch films. The skilled artisan will also appreciate that that the incorporated herbicides can bleed out from both sides of the film, thereby reducing the herbicidal effect

U.S. Patent Application 2008/0312086 discloses a transparent pest control sheet, for the use in agriculture, horticulture and gardens. The pest control sheet described consists of at least two layers, with an herbicide and optionally one or more pesticides selected from among fungicides and insecticides incorporated in the bottom layer. Also the top layer can optionally contain an insecticide and/or fungicide. It is disclosed that the sheet is applied before the plants are planted and that the pesticides is slowly released during the whole season till harvest. Transparent herbicidal mulching multilayer films are also described in the JP Patent 62175129 (A). One layer is made of a triazine herbicide with a low water solubility and a melting point equal or above 130° C. blended with a polyethylene copolymer resin having a melting point at least 50° C. lower than the herbicide, and a diffusion-preventing barrier layer. The films exhibit long-term herbicidal effect for the use in agricultural production. The long-term herbicidal effect of the films is exemplified demonstrated in Chinese cabbage production for a period of 60 days. It is also demonstrated that after 60 days the films still contain 20% of the initial herbicide concentration.

U.S. Patent Application 2009/0156406 describes a biocide composite material with barrier functionality for the use as mulch film together with fumigants in agricultural production. The composite material comprises at least one base polymer compound and at least one biocide active ingredient, wherein the biocide can also be a pesticide. The biocide active ingredient is incorporated into one or multiple coating layers. The application teaches that the biocide can be emitted from the polymer composite material by diffusion and/or osmosis and that the biocide polymer composite materials have a long lifespan.

U.S. Pat. No. 5,288,532 describes transferable modifier-containing films for food packaging and disclose inter alia water swellable extruded films of at least three layers including a core-oxygen barrier layer, a layer on one side of said barrier layer comprising a blend of polyethylene polymer and 15 to 40% by weight of a water-soluble olefinic oxide polymer such as poly (ethylene oxide) and inter alia a biocide as modifier, and another layer formed of thermoplastic material on the other side of the core-oxygen barrier layer. The modifier is transferable from the film enclosure to the food outer surface during processing by fluid transfer, which requires a physical contact between the modifier-containing film layer surface and the receiving food surface either by shrink packaging or by wrapping the film closely around the food to be processed. The use of these films for agricultural production is not claimed, apparently because the required close physical contact to the soil is not possible under real conditions in agricultural production.

Common methods to make multilayered plastic mulch films known by a skilled artisan are either cast coextrusion or blow coextrusion. Coextrusion means extruding one or more materials simultaneously through a single die by arranging the orifices in the die such that the layers merge together before cooling.

Cast coextrusion is a high volume manufacturing process in which raw plastic material is melted and formed into a continuous profile inside an extruder followed by cooling of the produced flat film by chill rolls or water. The blown film coextrusion process involves extruding a tube of molten polymer through a die and inflating to several times its initial diameter to form a thin film bubble. This bubble is cooled by air then collapsed and used as a lay-flat film or can be made into bags.

According to the above described publications, the pesticides can be incorporated into a master batch prepared by mixing or/and blending polymers and pesticides utilizing conventional compounding methods before extrusion into films or sheets or by adding the pesticide directly to the extruder of the film or sheet forming extrusion line.

Conventional compounding methods using single and twin extruders with different screw configurations and downstream equipment like die face, strand pelletizing and underwater pelletizing systems. These methods were proven in the industry to be very cost effective, reliable and meet vast majority of polymer manufacturing expectations and demands. U.S. Pat. No. 2008/0312086 as an example did use the above conventional compounding methods to form polymeric pellets which contain a pesticide.

It is known from a numerous scientific publications, see overview R. Wilkins in Encyclopedia of Agrochemicals, Vol. 1, pp 386-398, 2003, John Wiley & Sons, Inc., that the plastic formulations of pesticides described in the art above consist of a uniform continuous polymeric phase with the pesticide dissolved or dispersed throughout and that the pesticide diffuses from the interior of the plastic formulation to its surface. Research into pesticide plastic formulation indicates that the diffusion of the pesticide to the film surface is very slow and that the complete release to the soil/crop takes several months up to several years, see e.g. M. Bahadir, Chemosphere, Vol. 12. No. 9/10, pp 1327-1336, 1983 or N. Cardelli in U.S. Pat. No. 4,400,374. As a consequence it is not a surprise for a skilled person that the films described in earlier publications provide a slow pesticide release during the whole season till harvest and that a substantial proportion of the pesticide remains entrapped in the plastic films even beyond harvest.

A persistent pesticide release till harvest is disadvantageous, because it is known that this leads to accumulation of pesticide residues in the harvested crop. A pesticide residue is that fraction of a pesticide, which because of its use, finds its way into produce, soil or water and is present there either as the original pesticide or in degradation products of the pesticide. These residues in food are a potential danger for consumer health. Experience has shown, however, that when the pesticide is registered for the crop, used in the correct dose and when a minimum period between application and harvest is observed, only minimal quantities of residue may remain that are proven to be tolerable to human health.

Therefore national and international regulatory authorities ensure that crops harvested are safe to eat and that future crops will not be affected by pesticide residues remaining in the soil by mandatory regulation to stop pesticide application at a certain period of time before harvest. This so called per-harvest interval allows sufficient time for the pesticide to degrade below tolerable maximum residue limits in the crop before harvest and in the soil before the next growing season. Typical days to harvest for non-perennial fruit and vegetables are usually in the range of 45 days to 120 days, e.g. 45 days for tomatoes, 90 days for watermelons and 120 days for peanuts, generally determined from the time transplants are planted through the films. Depending on the crop and the degradation time of the pesticide its application is required to stop 7 days, e.g. Metribuzin application in tomatoes, 57 days for Halosulfuron-Methyl or 90 days, e.g. Metolachlor in peanuts before harvest. “The International Pesticide & Application Database (IPAD)” lists pesticides by chemical brand name, method of application, rates and frequency of application, maximum residue limits as well as pre- and post-harvest intervals.

The skilled artisan will readily appreciate that persistent pesticide release until and beyond harvest of the pest controlling films and sheets increase the risk to exceed the lawful tolerable maximum residue limits of pesticides in the harvested crops or in the soil. In addition the pesticides remaining in the film at the end of its useful life prevents its recycling or safe disposal.

The aforementioned disadvantages of the art pesticide releasing plastic films and sheets may explain why they are neither registered for use in agricultural production of specialty crops nor commercial available yet.

Due to the toxic nature of pesticides, conventional compounding approaches described hereinabove, though effective, do not eliminate the adverse environmental impact on the environment due to the generation of solid and water by-product toxic wastes.

Furthermore, such methods require excessive maintenance which adds another challenge and risk associated for personnel physically involved. e.g. electrical heating elements, regular screw and barrel cleanup maintenance, cooling fans, heat exchanger maintenance and cleanups, solenoid valves, maintenance of pelletizing units, etc. . . . . Pesticides are delicate chemicals that require proper understanding and handling. For example, the accumulation of pesticides for prolonged times over the electrical heating units of an extruder barrel or in a Banbury mixer poses a hazardous potential. Most modern pesticides are made with the built-in ability to degrade as fast as possible under various environmental conditions, including microorganism, humidity and temperature.

Modern pesticides may produce toxic by-products during compounding by thermal degradation, which can harm operators or the environment as may be recognized by skilled artisan from the abundance of literature dealing with the thermal decomposition of pesticides.

Therefore, there is a need for films usable for agricultural and like uses that are capable of carrying active ingredients while meeting regulations regarding presence of pesticides in crops at the time of harvest and regulations regarding presence of pesticides, chemicals, and other active ingredients in consumable products. Uses of such films could include mulch films for horticultural and agricultural applications, and other uses for preservation of perishable products following harvest or following transformation.

### SUMMARY

According to the present disclosure, there is provided a pesticide-releasing multilayer film comprising an outer (bottom) layer facing earthward. The outer (bottom) layer comprises 92 to 98.99% by weight of water-insoluble polyethylene homo- and copolymers, about 1 to 5% by weight of a water-soluble polymer, and 0.01 to 3% by weight of at least one pesticide. The multilayer film also comprises a pesticide-free middle layer assembly. The pesticide-free middle layer comprises at least one middle layer. The multilayer film further comprises a further outer (top) layer facing skyward. The further outer (top) layer comprises 92 to 98.99% by weight of water-insoluble polyethylene homo- and copolymers, about 1 to 5% by weight of a water-soluble polymer, and 0.01 to 3% by weight of at least one pesticide.

According to the present disclosure, there is also provided a plastic article comprising the pesticide-releasing multilayer film.

According to the present disclosure, there is also provided a blow extrusion method for manufacturing the pesticide releasing multilayer film. 60 to 99% by weight of at least one water-soluble polymer is premixed with at least one pesticide. 1 to 40% by weight of the at least one pesticide is in a melt set at appropriate temperature in a hot jacketed mixer with variable mixing speeds, thereby generating a premix. The premix is cooled and the resulting premix is pulverized. The premix is added as an admixture in 1 to 10% by weight to a water-insoluble polymer. The multilayer film is generated by blow extrusion.

The present disclosure further relates to a pesticide compound composition comprising at least one pesticide, at least one water-soluble polymeric material as a carrier resin, and none or at least one supplemental water-insoluble polymeric material as a carrier resin. The at least one water-soluble polymeric material is incompatible with the polyolefin materials of the pesticide-releasing multilayer film, and is selected from the group consisting of polyvinyl alcohol, polyvinylpyrrolidone, polysorbate, poly (ethylene oxide), non-ionic polymers, water-soluble polymers which can cross-link to form gels and combinations thereof. The supplemental water-insoluble polymeric carrier resin is compatible with the polyolefin materials of the pesticide-releasing multilayer film, and is selected from the group consisting of homopolymers, copolymers, waxes, biocompatible polymers, derivatives and combinations thereof.

According to the present disclosure, there is also provided a method of preparing the pesticide compound composition in a hot jacketed mixing unit. At least one pesticide, at least one water-soluble polymeric material, none or at least one water-insoluble polymeric material and optionally one or more additive(s) are added in a mixing vessel or a tank. A premix is prepared by cold mixing the least one pesticide, the at least one water-soluble polymeric material, the at least one water-insoluble polymeric material (if present) and the one or more additive(s) (if present) under low shear conditions for adequate time. The mixing vessel is appropriately heated to create the correct conditions to prepare agro concentrate mix. Mixing speed and duration of mixing are alternated to provide proper thermal distribution and adequate dispersion of viscous mix. The premix temperature is reduced. The molten premix is discharged and transferred to a dry cooling unit. The molten premix is cooled in the dry cooling unit by convection, conduction or a combination of both techniques.

The present disclosure also relates to a method for pest control in specialty crops comprising physical preparation of a field and soil for planting of the crops. The pesticide-releasing multilayer film is placed on the prepared field so that the outer (bottom) surface faces earthward towards the soil to completely cover the surface of the field. The film is punctured after an induction period of 7 to 14 days at the spot where a seedling is intended to be planted so that a seedling can be inserted through the hole and planted in the soil.

The present disclosure further relates to a multilayer film for releasing an active ingredient. The multilayer film comprises an outer layer composed in part of a water-soluble polymer fraction containing the active ingredient, and a further outer layer.

According to the present disclosure, a multilayer film bag is also provided. The multilayer film bag comprises an internal layer. The internal layer comprises 92 to 98.99% by weight of water-insoluble polyethylene homo- and copolymers, about 1 to 5% by weight of a water-soluble polymer, and 0.01 to 3% by weight of at least one active ingredient. The multilayer film bag also comprises an external layer.

The present disclosure also relates to a blow extrusion method for manufacturing the multilayer film bag. 60 to 99% by weight of at least one water-soluble polymer is premixed with at least one active ingredient. 1 to 40% by weight of the at least one active ingredient is in a melt set at appropriate temperature in a hot jacketed mixer with variable mixing speeds, thereby generating a premix. The premix is cooled and the resulting premix is pulverized. The premix is added as an admixture in 1 to 10% by weight to a water-insoluble polymer. The multilayer film is generated by blow extrusion.

The present disclosure further relates to an active ingredient composition comprising at least one food preservative, at least one water-soluble polymeric material as a carrier resin and none or at least one supplemental water-insoluble polymeric material as a carrier resin. The at least one water-soluble polymeric material is incompatible with the polyolefin materials of the multilayer film bag, and is selected from the group consisting of polyvinyl alcohol, polyvinylpyrrolidone, polysorbate, poly (ethylene oxide), non-ionic polymers, water-soluble polymers which can cross-link to form gels and combinations thereof. The supplemental water-insoluble polymeric carrier resin is compatible with the polyolefin materials of the multilayer film bag, and is selected from the group consisting of homopolymers, copolymers, waxes, biocompatible polymers, derivatives and combinations thereof.

According to the present disclosure, a method of preparing the active ingredient composition in a hot jacketed mixing unit is provided. At least one food preservative, at least one water-soluble polymeric material, none or at least one water-insoluble polymeric material and optionally one or more additive(s) are added in a mixing vessel or a tank. A premix is prepared by cold mixing the least one food preservative, the at least one water-soluble polymeric material, the at least one water-insoluble polymeric material (if present) and the one or more additive(s) (if present) under low shear conditions for adequate time. The mixing vessel is appropriately heated to create the correct conditions to prepare an active ingredient concentrate mix. Mixing speed and duration of mixing are alternated to provide proper thermal distribution and adequate dispersion of viscous mix. The premix temperature is reduced. The molten premix is discharged and transferred to a dry cooling unit. The molten premix is cooled in the dry cooling unit by convection, conduction or a combination of both techniques.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a schematic cross-sectional view of a multilayer film according to an embodiment;

FIG. 2 is a schematic cross-sectional view of a multilayer film having sub layers in its middle layer according to another embodiment; and

FIG. 3 is a schematic cross-section view of a multilayer film bag according to yet another embodiment.

### DETAILED DESCRIPTION

Various aspects of the present disclosure generally address one or more of the problems related to potential presence of pesticides in crops at the time of harvest. Other aspects of the present disclosure generally address one or more problems related to preservation of perishable goods, for example harvested products and prepared food products. More specifically, the present disclosure provides a multilayer film capable of releasing an active ingredient. The multilayer film comprises an outer layer composed in part of a water-soluble polymer fraction containing an active ingredient, a further outer layer and may comprise a middle layer. The outer layer may comprise the water-soluble polymer fraction and a water-insoluble fraction. Relative proportions of the water-soluble polymer fraction and of the water-insoluble fraction provide a pre-determined time of release of the active ingredient when the multilayer film is exposed to humidity.

Accordingly, pesticide-releasing plastic mulch films and sheets for horticultural specialty crop production are able to end up pesticide release before the start of the per-harvest interval, reaching very low levels of remaining pesticides in the mulch films and sheets, to provide safe to eat crops and to meet regulatory requirements regarding crop rotation and film waste disposal. Alternatively, films capable of releasing active ingredients, comprising for example pesticides, fungicides or preservatives, may be used to form bags able to release substantially all of the active ingredients within a predictable and limited time period, the bags then being usable for carrying and protecting produce while minimizing levels of active ingredients in the produce at the time of consumption. Some level of pesticides or other active ingredients may remain in the mulch films or bags, and into the crops or produce, at the end of a planned release period, as the intent is not to meet an absolute zero level of active ingredients, but rather to meet regulatory requirements regarding such ingredients. The present disclosure also provides a method for the production of a polymer material containing pesticides for the production of pesticide-releasing plastic mulch films capable of releasing pesticide over a limited time period. Also provided is a method for the production of a polymer material containing active ingredients for the production of bags capable of releasing the active ingredients over a limited time period. The present disclosure further provides a compounding method that is safe, practical and suitable for applications involving delicate active ingredients such as pesticides, fungicides and preservatives. The present disclosure also teaches manufacture of active compounds that may be used effectively in the manufacturing of multilayered plastic mulch films for agricultural use and of multilayered plastic bags for preservation of perishable goods. The present disclosure further provides a blow film coextrusion process that may match specific processing requirements of minimum melt temperature and effective air cooling to minimize risks of degrading the active ingredient without scarifying productivity and quality. Other objectives, advantages and improvements will also become apparent to the skilled artisan as the description proceeds in more details below.

In an aspect, the present disclosure provides blown extruded multilayer area-measured plastic articles of at least three layers for specialty crop production comprising of at least one outer layer with pesticide(s) or other active ingredient(s) incorporated comprising of 92 to 98.99% by weight polyethylene homo- and copolymers, about 1 to 5% by weight of a water-soluble polymer and 0.01 to 3% of pesticide(s) with said pesticide(s) being released over a limited period of time from said outer layer earthward to the soil and/or from the other outer layer skyward to the film surface till the start of the pre-harvest interval, a pesticide-free middle layer assembly consisting of at least one of a polymeric material and a process for the manufacturing of such area-measured plastic articles with incorporated pesticides by premixing 60 to 99% by weight water-soluble polymer with 1 to 40% by weight of the desired pesticide(s) in the melt at appropriate temperature setting in a hot jacketed mixer with variable mixing speeds, cooling and pulverizing the resulting premix and adding the premix as admixture in amounts of 1 to 10% by weight to a water-insoluble polymer, for example polyethylene homo- and copolymers feed for the outer layer(s) of a multilayer die head to blow extruded multilayered films, sheets or bags and their use in specialty crop production.

In another aspect, the present disclosure provides pesticide compositions and a compounding method for agriculture use. Such compounds are prepared using hot jacketed mixing unit. Said compounds hereinafter “agro concentrates” can be utilized, but not limited, as admixture for the preparation of extruded polymeric films or sheets, wherein, the final composition of layered films or sheets could be composed partially or fully, as may be required by the skilled artisan. The term “agro concentrate” in the description to follow applies to compounds pesticides prepared using hot jacketed mixer method.

In a further aspect, the present disclosure also provides a method for a low shear heating and controlled temperature low shear blown extrusion process for multilayered films.

The present disclosure is therefore based on recognition of a need to develop a method to compound agro chemicals that provides a practical level of process and toxic control and carries a solution to the aforementioned disadvantages. This disclosure provides a more efficient process, safer and more effective method mainly for agricultural purposes.

Crop protection is the branch of horticulture concerned with protecting crops from pests, weeds, disease and encompasses inter alia Pesticide-based approaches. A pesticide crop protection product consists of two parts: active and inert ingredients. Active ingredients are chemicals which actually control the pest, like herbicides, insecticides, nematicides and fungicides. A pesticide active ingredient in a relatively pure form rarely is suitable for field application and is usually formulated with additives, so called inert ingredients to increases pesticide effectiveness in the field. Pesticide formulations generally contain solvents, solid inorganic carriers, surface active agents and special rheological additives as inert ingredients to form concentrates for dilution with water for spray application or undiluted application for incorporation into the soil.

And, it has now been found that pesticide releasing multilayer films with an outer layer(s) comprising of a blend of polyethylene homo- and copolymers and an agro concentrate of a water-soluble polymer and the pure form of one or more pesticides according to the present disclosure can be tailored to provide release of pesticide over a predictable and limited time period while providing pesticide effectiveness in the field.

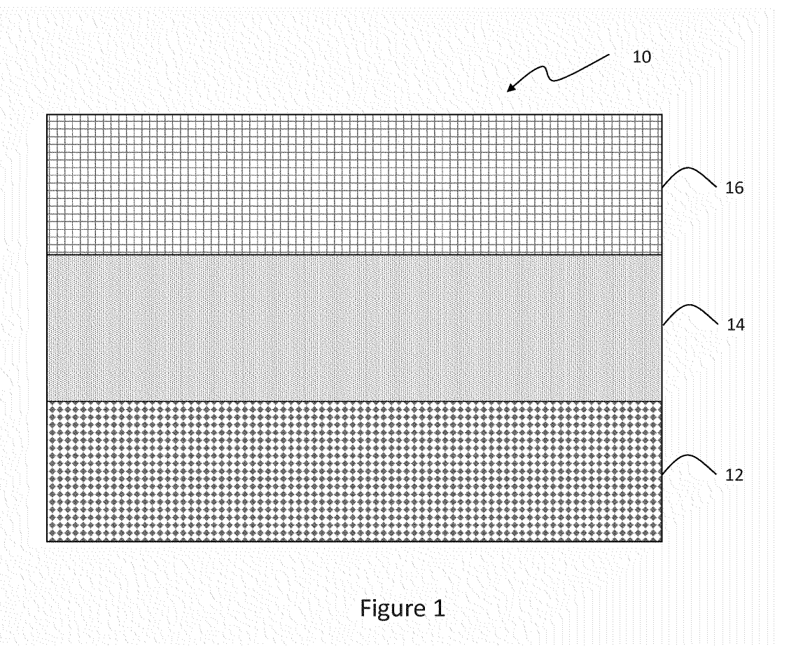

For example, FIG. 1 is a schematic cross-sectional view of a multilayer film according to an embodiment. As shown on FIG. 1, an illustrative embodiment of the present disclosure includes a multilayer film 10 including a lower, earthward layer 12, an upper, skyward layer 16, and a middle layer 14. FIG. 1 is not to scale and each layer 12, 14, 16 may have a distinct thickness. FIG. 1 is thus greatly simplified for ease of illustration. The multilayer film 10 includes a blend for at least one outer layer comprising about 1 to 5% by weight of a water-soluble polymer and 92 to 98.99% by weight of a water-insoluble polyethylene homo- and copolymers derivatives or mixtures and blends thereof and 0.01 to 3% of pesticide(s) with said pesticide(s) to be the in pure form selected from a group of insecticides, nematicides, fungicides and herbicides registered for the use in specialty crops

Suitable water-soluble polymer in the present disclosure for the use in the earthward outer layer or and in the skyward outer layer of the multilayer area-measured plastic articles may be any suitable water-soluble polymer that withstands fabrication to molded polymeric components via extrusion, injection blow molding, or blown film extrusion, such as, but not limited to polyvinyl alcohol, Poly vinylpyrrolidone, poly sorbate or poly (ethylene oxide).

For example, another illustrative embodiment of the present disclosure includes a water-soluble polymer such as polyvinyl alcohol having a relatively low average molecular weight within the range of about 25,000 to 50,000, which can contain plasticizers, such as glycerol, polyethylene glycol, sorbitol, and other suitable compounds for melting point depression to become moldable.

In a variant, the present disclosure includes a water-soluble polymer such as poly vinylpyrrolidone having an average molecular weight within the range of about 25,000 to 1,000,000.

In another variant, the present disclosure includes Polysorbate deriving from polyethoxylated sorbitan esterified with fatty acids having a molecular weight within the range of 1,000 to 1,500.

A further variant of the present disclosure comprises a water-soluble polymer such as poly (ethylene oxide) having a molecular weight ranging from about 100,000 to about 8,000,000, which becomes thermoplastic and can be formed by molding, extrusion and other methods known in the art without the use of plasticizer.

The outer layers of the multilayered films of the present disclosure may for example include polyethylene homo- and copolymers as water-insoluble polymers including low density polyethylene (LDPE), high density polyethylene (HDPE) and linear low density polyethylene (LLDPE; refers to copolymers of ethylene with one or more comonomers selected, for example, from C4 to C10 alpha-olefins such as butene-1 or, octane) or copolymers of ethylene and another hydrocarbon as for example ethylene vinyl acetate (EVA), ethylene acrylic and (EAA), or blends thereof.

Insecticides useful for the earthward layer of films or sheets according to the present disclosure (noted according to their common names and already registered for the use in specialty crops) are for example but not limited to the following insecticides, having a pre harvest interval within the range of 1 day to 90 days: imidacloprid, abamectin, permethrin, esfenvalerate, dazinon, dimethoate, deltamethrin, difluebenzuron, dicofol, methomyl, malathion, azadirachtin, propargite, pyrellin, pyrethrins, carbaryl, methidathion, endosulfan, trigard, fenbutatin-oxide.

Nematicide useful for the earthward layer of films or sheets according to the present disclosure (noted according to their common names and already registered for the use in specialty crops) are for example, but not limited to the following nematicdes, having a pre harvest interval of 1 day to 90 days: Abamectin, carbamate and organophosphorus nematicides, Captan, Thiophanate-methyl, Thiabendazole, Fluopyram.

Fungicides useful for the earthward layer of films or sheets according the present disclosure (noted according to their common names and already registered for the use in specialty crops) are for example, but not limited to the following fungicides, having a pre harvest interval within the range of 1 day to 90 days: Fosetyl-aluminium, benomyl, chlorothalonil, fenamidone, fluopicolide, Fluopyram, mancozeb, maneb, mefenoxam, iprodione, thiophanate-methyl

Herbicides useful for the earthward layer of films or sheets according to the present disclosure (noted according to their common names and already registered for the use in specialty crops) are selected from a group of herbicides comprising, but not limited to herbicides, having a pre harvest interval within the range of 1 day to 90 days: bensulide, clethodim, carfentrazone-ethyl, cycloate, fluazifop, glyphosate, Halosulfuron-methyl, sethoxydim, metolachlor, oxyfluorfen, pronamide, prometryn, pendimethalin, pyrazon, phenmedipham, trifluralin.

Conservation tillage practices such as no-till or strip-till leave residue and inoculum of plant pathogens on the soil surface outside the area which will be covered with a plastic mulch film. Inoculum can be carried from such soil surfaces to the film surfaces by air currents, by water splash, or via a vector species, such as an insect.

In accordance to yet a further embodiment of the disclosure the skyward outer layer may contain as pesticides insecticide to protect the crop from vector insects crawling across the film surface and/or fungicides to protect fruits resting on the film from fungi infestation by germinating fungi spores splashed onto the film or sheet surface.

Insecticides useful for the skyward layer of films or sheets according to the present disclosure (noted according to their common names and already registered for the use in specialty crops) are for example but not limited to the following insecticides, having a pre harvest interval within the range of 1 day to 90 days: imidacloprid, abamectin, permethrin, esfenvalerate, dazinon, dimethoate, deltamethrin, difluebenzuron, dicofol, methomyl, malathion, azadirachtin, propargite, pyrellin, pyrethrins, carbaryl, methidathion, endosulfan, trigard, fenbutatin-oxide.

Fungicides useful for the skyward layer of films or sheets according to the present disclosure (noted according to their common names and already registered for the use in specialty crops) are for example, but not limited to the following fungicides, having a pre harvest interval within the range of 1 day to 90 days: Fosetyl-aluminium, benomyl, chlorothalonil, fenamidone, fluopicolide, Fluopyram, mancozeb, maneb, mefenoxam, iprodione, thiophanate-methyl.

One aspect of the present disclosure is to prevent the bleeding out of pesticides from one outer layer to the other outer of the multilayer area-measured plastic articles by a pesticide-free middle layer or layers of polymeric film between the outer layers.

In an embodiment, the present disclosure includes an active ingredient-free middle layer made of:

a) low density polyethylene (LDPE) or a high density polyethylene (HDPE) and optionally a surfactant suitable to migrate to the outer surface of the pesticide-free layer, i.e. glycerol esters of fatty acids, alkoxylated alkyl phenols, and polyalkoxylated fatty acid esters or

b) a polyamide resin which can be a polyamide, such as nylon 6, or a polyamide copolymer such as nylon 6/66 or

c) an ethylene vinyl alcohol copolymer containing, for example, 25 to about 50 mol percent ethylene.

According to yet another embodiment of the disclosure, the blend for the outer layers may further comprise additives that are intended for achieving the desired properties of the multi area plastic articles. The group of additives which are well known comprises colorants, ultraviolet (UV) absorbers, inhibitors and or light stabilizers, anti-blocks which are based on amorphous and crystalline silicates or Kaolin; slip agents selected from among amides, oleamide, stearamide and derivatives thereof; lubricants selected from among polyolefine waxes, PE waxes and PP waxes and metal stearates; anti-oxidants, anti-fog additives, selected from glycerol esters of fatty acids, alkoxylated alkyl phenols, and polyalkoxylated fatty acid esters. Other additives may be applied as may be appreciated by the skilled artisan

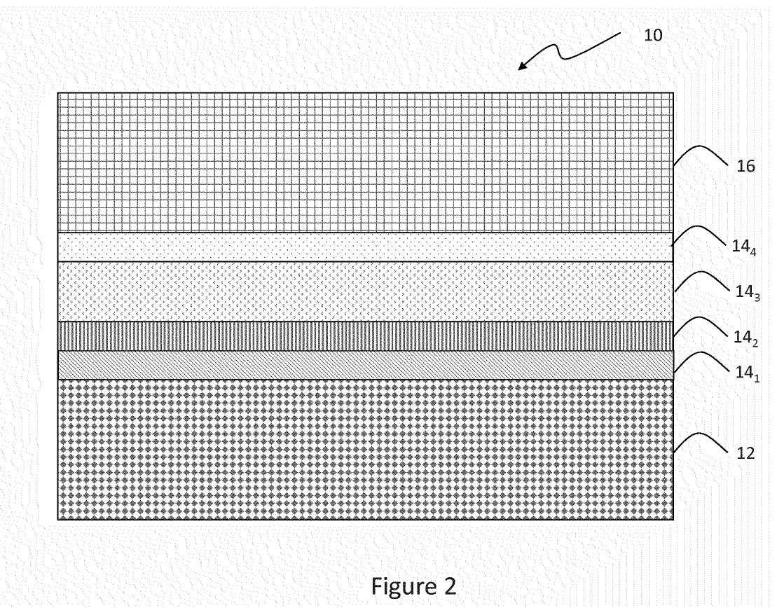

FIG. 2 is a schematic cross-sectional view of a multilayer film having sub layers in its middle layer according to another embodiment. FIG. 2 shows that the pesticide-free middle layer may be a composite of sub layers 14₁, 14₂ . . . 14ₙ, for example three (3) to five (5) sub layers. FIG. 2 is not to scale and each layer or sub layer 12, 14₁, 14₂ . . . 14ₙ, 16 may have a distinct thickness. Definition of the middle layer 14 into sub layers helps preventing delaminating of the multilayer area-measured plastic article according to this disclosure in such cases when the materials of the pesticide-free layer and the blend material of the outer layer according to the present disclosure do not bond easily together. To prevent delaminating, materials for the pesticide-free middle layer are sandwiched between small layers known as “tie layers” comprised of cyclic anhydride modified polyolefin resins to form the three sub layered composite. In case that the blend material for the outer layer may contain at a pesticide which is sensitive to anhydride groups or acid conditions by reaction or decomposition the three sub layered composite is sandwiched between two sub layers of low density polyethylene (LDPE) or high density polyethylene (HDPE) to form a five layer composite middle layer with no direct contact of the tie layers with the pesticides.

The present disclosure also provides a pesticide composition compounding method for agriculture use. Such compounds are prepared using hot jacketed mixing unit. Said compounds hereinafter “agro concentrates” can be utilized, but not limited, for the preparation of polymeric films or sheets, wherein, the final composition of layered films or sheets could be composed partially or fully, as may be required by the skilled artisan. The term “agro concentrate” in the description to follow applies to compounds of herbicides, nematicides, fungicides and insecticides prepared using hot jacketed mixer method.

The following description is a brief demonstration of the present disclosure that is not to be constructed as limiting. The skilled artisan having the benefit of the present disclosure will be able to carry out different variations to the design of the equipment, tools and processing conditions of the present disclosure.

According to a particular embodiment of the disclosure, the agro concentrate of the present disclosure is composed of none, one or more water-insoluble polymeric materials, known in compounding industry as carrier resins, normally compatible with the polyolefin materials used for the plastic mulch film or sheet. Said polymeric materials are selected but not limited from a group comprising homopolymers, copolymers, waxes, biopolymers, derivatives or other mixtures as may a suitable choice of skilled artisan be.

The rate of release of pesticides using water-soluble polymers, as a carrier resin for agro concentrates, was determined to be an effective method compared to earlier techniques. Said carrier resins selected are biocompatible polymers, non-ionic, water-soluble polymers which can easily cross-link to form gels. It is important to note that water-soluble polymers and polyolefin are recognized by skilled artisan as incompatible polymers.

Furthermore, water-soluble polymers are sensitive polymers to high mechanical shear stress and prolonged thermal exposures causing undesired cross-linking and therefore formation of water-insoluble gel particles. Well known conventional compounding methods require high processing temperatures to insure optimum dispersion and distribution of active ingredients within the polymer matrix. Also, such methods are solely based on high mechanical shear stresses. The present disclosure, using hot jacketed mixer method, provides the lowest processing temperature required associated with minimal mechanical shear stresses.

In addition, conventional pelletizing systems (downstream equipment of conventional compounding lines) utilize water to cool molten polymer through direct contact with water media. Water-soluble polymers cannot be cooled by direct contact with water, because of their inherent ability to dissolve in water, which would cause the pesticides to leach-out to the water too. Hence, conventional pelletizing systems are not practical methods for the use in the manufacturing of agro compounds with water-soluble polymers as carrier resin and should be avoided.

The present disclosure uses dry cooling methods to overcome the aforementioned disadvantages. Said cooling methods could be by conventional heat transfer means utilizing, but not limited to, dry air, Nitrogen gas, Carbon dioxide gas, etc. . . . or by conduction heat transfer means using cooling jackets, as an example, to extract, indirectly, the energy from the molten polymer under controlled environment provisions to prevent possible water condensation at the cold hot interface.

According to a further embodiment of the disclosure, agro concentrates may contain one pesticide or combination of pesticides from a group of insecticides, nematicides, fungicides and herbicides registered for the use in specialty crops as may be appreciated by the skilled artisan.

Furthermore, agro concentrate intended for the preparation of the earthward layer (hereinafter, “earthward concentrates”) may contain one pesticide or combination of pesticides selected from the group of insecticides, nematicides, fungicides and herbicides registered for the use in specialty crops by 0.5% to 40% by weight. Agro concentrate intended for the preparation of the skyward layer (hereinafter, “skyward concentrates”) may contain one pesticide or a combination of pesticides selected from the group of insecticides, and fungicides registered for the use in specialty crops 0.5% to 40% by weight.

The present disclosure, as may be appreciated by the skilled artisan, may produce also agro concentrate containing only one or a combination of pesticides selected from insecticides, nematicides, fungicides or herbicides in about 0.5% to 40%. The skilled artisan will appreciate that nematicides and herbicides containing agro concentrate are solely intended for the preparation of earthward layer of film or sheet. The skilled artisan having the benefit of the present disclosure will be able to carry out different variations to the concentrations and possible combinations of insecticides, nematicides, fungicides and herbicides in the final agro concentrate of the present disclosure.

Furthermore, the agro concentrate of the present disclosure is in pulverized flaky polymeric form subsequent to cooled properly encapsulated pesticides within mainly water-soluble polymeric matrix. The skilled artisan having the benefit of the present disclosure will be able to carry out different variations to the final shape and geometry of downsized agro concentrate product depending on the tools and equipment used.

Agro concentrates of the present disclosure may contain other type of additives that are important for achieving the desired properties of end product. Said additive materials could be selected but not limited to a group comprising primary, secondary amides and derivatives of slip agents, organic and inorganic Antiblocks, UV absorbers, inhibitors and or light stabilizers, lubricants, metal stearates, waxes, or other additives as may a suitable choice of skilled artisan be.

The following description of present disclosure is for demonstration purposes and should not be constructed as limiting. The agro concentrates of the present disclosure of both earthward and skyward concentrates can be prepared according to a technique known by skilled artisan as hot jacketed mixers, vessels or tanks. According to said technique, pesticides with possible supplemental additives and carrier resins are added to the mixing vessel or tank. The desired weight percentage of each component can be controlled using, but not limited to, gain in weight and loss in weight automated feeding systems. The mix will go first under cold mixing process for adequate time to insure sufficient distribution of the mix hereinafter “premix” at an appropriate mixing speed with proper mixing blade configurations. The mixing speed is appropriate and the mixing blade configuration is proper if they enable low shear mixing. The temperature of mixing vessel is set accordingly to create sufficient heating conditions to prepare the agro concentrate mix. Mixing speed and mixing duration will be adjusted as the premix changes from solid phase to molten phase. Further adjustment of mixing speed and duration of mixing of molten mix may be required to provide proper thermal distribution and adequate dispersion of viscous mix. Reduce temperature setting of mixing vessel in preparation to discharge the molten mix. A mechanical and or electrical discharge unit can be used to empty the hot mixing vessel. The discharged material is then transferred to a dry cooling unit in a form of chunks or sausages by conveying belts or any other practical conveying methods. Cooling process can be achieved by convection, conduction or combination of both techniques as may be appreciated by the skilled artisan. Use appropriate screen size to pulverize polymer chunks to acceptable particle size range. The final product is in a pulverized flaky polymeric form suitable for Agro film manufacturing process.

The abovementioned technique is suitable to produce earthward and skyward concentrates as addition may be required for final agro film or sheet product.

Other hot jacketed mixing techniques known in the art may be used for the preparation of agro concentrate of present disclosure.

The present disclosure also provides a blown extrusion process for multilayer area-measured plastic articles of at least three layers comprising pesticides for agriculture use.

It is known that blow coextrusion requires lower processing temperatures than cast extrusion which is advantageous for processing of delicate pesticides compounds but also that blown film extrusion has a less effective cooling process than flat film, which is disadvantageous for processing of delicate pesticides compounds. The specific heat capacity of chill rolls or water used in the cast film cooling process is significantly higher than the specific heat capacity of air that is used in the blown film cooling process. The cooling efficiency of blown film coextrusion could be simply improved by reducing the temperature of the polymer melt but this would also reduce productivity and film quality as known by the skilled artisan.

The process involves co-extrusion of plastic melt for each number of layers, usually vertically, through a circular die, to form a thin walled tube. The tube of the multilayered film then continues upwards, continually cooling, until it passes through nip rolls where the tube is flattened. The flatted film is then either kept as such or the edges are slit off to produce two flat film sheets or made into bags by sealing across the width of film and cutting or perforating to make each bag. Application of multilayer film technology for producing bags useful in the protection of perishable goods is described in more details hereinbelow.

The agro concentrates are fed directly to the polyethylene homo- and copolymers feed for the outer layer(s) of a multilayer die. A low shear heating and controlled melt temperature extrusion process is accomplished by the appropriate selection of screw configuration capable of providing effective distributive mixing with very low shearing energies and concomitant very low temperature rises in the material. Furthermore, the outer layers of the multilayered films of the present disclosure are selected from a group of polymers comprising of polyethylene homo- and copolymers or other blends thereof process-able at lower temperatures associated with higher melt flow index (MFI) ranging in values but not limited to two (2) to twenty (20) MFI.

Each layer in the multilayer die is precision made and as such may be expensive; however, their service life is considerable. Each die head has a working range of die inserts at different diameters to suit the required application. Different die gaps can also be specified depending on the material being extruded.

Typically, the Blow Up Ratio (BUR) of blown film could range from 1.5 to 5.0. The drawdown between the melt wall thickness and the cooled film thickness occurs in both Transverse directions (TD) and Machine direction (MD) and is easily controlled by changing the volume of air inside the bubble and by altering the haul off speed. This gives blown film a better balance of properties than traditional cast or extruded film or sheet which is drawn down along in machine direction only.

The multilayered films, sheets and bags may be about 0.5 to 8 mils in thickness, having for example a thickness of about 1 to 2 mils for the use as films. The pesticide-free layer may make up about 40 to 70 percent of the thickness while the outer layers may make up about 30 to 60 percent of the thickness.

The method of film production generally provides smooth films, sheets and bags, which optionally can be followed by a post-embossed process in line with or at a later stage to provide films, sheets and bags with textured surfaces.

The blown film, sheets and bags can be used in agricultural either in tube form, for making bags, or the tube can be slit to form a sheet (e.g. for greenhouse film) or to form a film (e.g. mulch film, fumigation film, or as propagation film

The present disclosure further provides a method for pest control in specialty crops, for example, but not limited to vegetable production. Said method may be applied in agriculture, horticulture or in garden maintenance.

In vegetable production said method is applied as follows: subsequent to physically preparing the field and soil for planting, e.g. plowing, fertilizing and laying down of an irrigation system, the plastic multilayered mulch film according to this disclosure is placed on the field with the earthward outer layer facing the soil to cover the surface of the field completely or the surface of raised beds formed on the field. The film is then punctured after an induction period of 7 to 14 days at the spot where a seedling is intended to be planted so that a seedling can be inserted through the hole and planted in the soil. The seedling is planted in such a manner that the roots are in the soil and the leaves are above the top layer in a manner that they do not come in contact with the surface of the earthward and skyward outer layer. Thus, the pesticides in the earthward layer control pests in the soil like nematodes, fungi, weeds, and optionally insects, via release of the pesticides into the soil over a limited period of time. When the multilayered mulch film contains pesticides in the skyward layer, then the plant or fruits resting on the film, e.g. in cucurbit production being protected from vector insects crawling across the film surface and/or germinating fungi spores splashed onto the film surface. Said method can be applied in gardens in a similar manner as described above.

It should be apparent to those skilled in the art that the pesticide releasing plastic multilayered mulch film according to this disclosure can be used also in combination with alternative fumigants to achieve complete soil sterilization. Alternative soil fumigants, for example chloropicrin, methyl iodide, 1,3-Dichloropropene, methyl isocyanate (including its precursors), or dimethyl disulfide.

It should be apparent to those skilled in the art that the pesticide releasing plastic multilayered mulch film according to this disclosure can be used also in combination with typical spray or drench application of typical pesticide crop protection products during the growing period before the start of the pre-harvest interval.

### Example 1

### Preparation of Earthward Herbicide Concentrate

The following description is a brief demonstration to prepare 5 kg earthward herbicide concentrate of the present disclosure that is not to be constructed as limiting. The skilled artisan having the benefit of the present disclosure will be able to carry out different variations, modifications and adaptations, without deviating from the fundamental ideas carried out of the present disclosure.

5 Kg earthward herbicide concentrate is prepared by weighing Halosulfuron-methyl herbicide chemical and poly (ethylene oxide) polymer at 1.03 and 98.97 weight percent respectively. Each component is fed to the mixing vessel through a separate port. Furthermore, each component has a separate weighing system. Both components are initially mixed together as a cold mix for a period of three minutes followed by heating the vessel for 20 minutes at reduced rpm throughout the transition state from solid to molten phase. Temperature of vessel afterward is reduced with adequate increase in mixing speed for five minutes. The discharge port of the mixing vessel is turned to an open position to discharge molten polymer into small/medium chunk sizes. A metal sheet is used to cool down chunks by conduction means for five to 10 minutes accordingly. A pulverizing unit is used afterward to down size the chunks to the desired geometry.

Manufacturing of a Three-Layered Film with an Earthward Herbicide Releasing Layer

A three-layer coex blown film extrusion line was used according to the present disclosure to produce an earthward herbicide film. The three ply A/B/C film was made by coextruding the middle layer C(C composed of nylon66), skyward layer B (B composed of 45% LLDPE Octene, 19% LLDPE Butene, 10% maleic anhydride concentrate, 25% white concentrate and 1% slip/antiblock concentrate) and Earthward layer A (A composed of 71% 2MFI LDPE, 10% maleic anhydride concentrate, 13.0% UV Black concentrate, 5% herbicide earthward concentrate and 1.0% slip/antiblock concentrate). The coextruded film is about 1.13 mil thickness comprised of 0.10 mil middle layer C, 0.71 mil skyward layer B and 0.32 mil earthward layer A. The throughput of extruders A, B and C were maintained around 127, 310 and 47 lbs/hr respectively. Furthermore, the size of said extruders A, B and C were 80 mm, 70 mm and 70 mm diameter respectively with L/D 26:1. The film was produced at 60.02″ wide using 16″ circular die and a total film density of 1.031 g/cm³. The flow of material is constantly controlled and adjusted in such a way, that the final amount of herbicide in the earthward layer of final plastic article is around 0.05% by weight.

### Field Studies:

All experiments presented in the following Tables I-IV were established on commercial farms using a commercial watermelon variety common to the region. Raised beds were formed using typical commercial farm equipment and were equipped with a center drip line for irrigation and fertilizers. Sprayed applied pesticides were used before laying standard mulch films at the maximum level recommended in the pesticide label. Standard and mulch films according to the present disclosure were placed on the bed by using a mechanized commercial mulch film layer.

Watermelon seedlings were transplanted 7 days after film installation.

Tables I and II summarize results obtained in a sandy soil field, in TyTy, Ga., USA:

TABLE I

| | Days after application | | | | | | |
|---|---|---|---|---|---|---|---|
| | 0 day | | | | | | |
| | Initial HSM | 20 days | | | | | |
| | concentration | HSM | | | | | |
| | in film at | content | | | 41 days | | 74 days |
| | application | in film | Nutsedge | Phytoxity | Nutsedge | Phytoxity | Yield |
| | [g/ha] | [g/ha] | [count/plot] | [%] | [count/plot] | [%] | [kg/plot] |
| Bare soil | 0 | 0 | 282 | n/a | 298 | 0 | n/a |
| Standard | 0 | 0 | 85 | 0 | 146 | 0 | 116 |
| mulch | | | | | | | |
| Sandea ® | n/a | n/a | 170 | 0 | 165 | 0 | 2 |
| spray | | | | | | | |
| [52 g/ha] | | | | | | | |
| 52 g/ha | 39 | 0 | 47 | 0 | 47 | 0 | 176 |
| Sandea ® | | | | | | | |
| spray under | | | | | | | |
| Standard | | | | | | | |
| mulch | | | | | | | |
| Experimental | 39 | 0 | 25 | 0 | 27 | 0 | 199 |
| Film with | | | | | | | |
| incorporated | | | | | | | |
| Sandea ® | | | | | | | |

TABLE II

| | Days after application | | | | | | |
|---|---|---|---|---|---|---|---|
| | 0 day | | | | | | |
| | Initial HSM | 20 days | | | | | |
| | concentration | HSM | | | | | |
| | in film at | content | | | 41 days | | 74 days |
| | application | in film | Nutsedge | Phytoxity | Nutsedge | Phytoxity | Yield |
| | [g/ha] | [g/ha] | [count/plot] | [%] | [count/plot] | [%] | [kg/plot] |
| Standard | 0 | 0 | 85 | 0 | 146 | 0 | 116 |
| mulch | | | | | | | |
| Sandea ® | n/a | n/a | 170 | 0 | 165 | 0 | 2 |
| spray | | | | | | | |
| [52 g/ha] | | | | | | | |
| 52 g/ha | 39 | 0 | 47 | 0 | 47 | 0 | 176 |
| Sandea ® | | | | | | | |
| spray under | | | | | | | |
| Standard | | | | | | | |
| mulch | | | | | | | |
| Experimental | 39 | 0 | 16 | 0 | 30 | 0 | 192 |
| Film with | | | | | | | |
| incorporated | | | | | | | |
| HSM | | | | | | | |

TABLE III

| | Days after application | | | | | | |
|---|---|---|---|---|---|---|---|
| | 0 day | | | | | | |
| | Initial HSM | 14 days | | | | | |
| | concentration | HSM | | | | | |
| | in film at | content | | | 45 days | | 90 days |
| | application | in film | Nutsedge | Phytoxity | Nutsedge | Phytoxity | Yield |
| | [g/ha] | [g/ha] | [count/plot] | [%] | [count/plot] | [%] | [kg/plot] |
| Standard | 0 | 0 | 0 | 0 | 20 | 7 | 185 |
| mulch | | | | | | | |
| Sandea ® | n/a | n/a | 0 | 0 | 74 | 37 | 81 |
| spray | | | | | | | |
| [52 g/ha] | | | | | | | |
| 52 g/ha | 39 | 0 | 0 | 0 | 0 | 3 | 487 |
| Sandea ® | | | | | | | |
| spray under | | | | | | | |
| Standard | | | | | | | |
| mulch | | | | | | | |
| Experimental | 39 | 0 | 0 | 0 | 0 | 2 | 489 |
| Film with | | | | | | | |
| incorporated | | | | | | | |
| Sandea ® | | | | | | | |

TABLE IV

| | Days after application | | | | | | |
|---|---|---|---|---|---|---|---|
| | 0 day | | | | | | |
| | Initial HSM | 14 days | | | | | |
| | concentration | HSM | | | | | |
| | in film at | content | | | 45 days | | 90 days |
| | application | in film | Nutsedge | Phytoxity | Nutsedge | Phytoxity | Yield |
| | [g/ha] | [g/ha] | [count/plot] | [%] | [count/plot] | [%] | [kg/plot] |
| Standard | 0 | 0 | 20 | 2 | 20 | 7 | 185 |
| mulch | | | | | | | |
| Sandea ® | n/a | n/a | 74 | 20 | 74 | 37 | 81 |
| spray | | | | | | | |
| [52 g/ha] | | | | | | | |
| 52 g/ha | 39 | 0 | 0 | 0 | 0 | 3 | 365 |
| Sandea ® | | | | | | | |
| spray under | | | | | | | |
| Standard | | | | | | | |
| mulch | | | | | | | |
| Experimental | 39 | 0 | 0 | 1 | 0 | 1 | 405 |
| Film with | | | | | | | |
| incorporated | | | | | | | |
| HSM | | | | | | | |

Sandea® is a selective herbicide EPA Reg. No. 10163-254 for control of listed broadleaf weeds and nutsedge marketed by Gowan Company, Yuma Ariz. Sandea® is a formulation containing 75% by weight Halosulfuron-methyl (HSM) as active ingredient and 25% Kaolin and Silica as inert ingredient. The maximum dose allowed for the use in watermelons is 0.75 oz/acre which translated to 52 g/ha equals 39 g/ha of the active ingredient Halosulfuron-methyl (HSM). Sandea® may be applied as a pre-transplant application under the plastic mulch for the suppression of nutsedge and control of listed broadleaf weeds. Application of Sandea® follows the final bed shaping and prior to the installation of the plastic mulch. Watermelons may be transplanted into this treated area no sooner than 7 days after the application and the installation of the plastic mulch. According to the label the required days between last application and harvest for Watermelons is 57 days. The time interval from transplanting to harvest mature watermelons is typically in the range of 80 to 95 days. HSM in the film is detected indirectly by HPLC with Mass spectroscopy combination from water/acetonitrile extract of 100 cm² film sample. Limit of quantification (LOQ) is 50 ng/I.

### Example 2

### Preparation of Earthward Fungicide Concentrate

5 Kg earthward fungicide concentrate is prepared by weighing Fluopicolide and Fenamidone as fungicide chemicals and poly (ethylene oxide) polymer at—3.335, 6.948 and 89.717 weight percent respectively. Each component is fed to the mixing vessel through a separate port. Furthermore, each component has a separate weighing system. All components are initially mixed together as a cold mix for a period of seven minutes followed by heating the vessel for 25 minutes at reduced rpm throughout the transition state from solid to molten phase. Temperature of vessel afterward is reduced with adequate increase in mixing speed for five minutes. The discharge port of the mixing vessel is turned to an open position to discharge molten polymer into small/medium chunk sizes. A metal sheet is used to cool down chunks by conduction means for five to 10 minutes accordingly. A pulverizing unit is used afterward to down size the chunks to the desired geometry.

### Example 3

### Preparation of Skyward Fungicide Concentrate

5 Kg skyward fungicide concentrate is prepared by weighing Fluopicolide fungicide chemical and poly (ethylene oxide) polymer at 3.59 and 96.41 weight percent respectively. Each component is fed to the mixing vessel through a separate port. Furthermore, each component has a separate weighing system. All components are initially mixed together as a cold mix for a period of four minutes followed by heating the vessel for 20 minutes at reduced rpm throughout the transition state from solid to molten phase. Temperature of vessel afterward is reduced with adequate increase in mixing speed for five minutes. The discharge port of the mixing vessel is turned to an open position to discharge molten polymer into small/medium chunk sizes. A metal sheet is used to cool down chunks by conduction means for five to 10 minutes accordingly. A pulverizing unit is used afterward to down size the chunks to the desired geometry.

Manufacturing of a Three-Layered Film with an Earthward and Skyward Fungicide Releasing Layers

A three-layer coex blown film extrusion line was used according to the present disclosure to produce an earthward and skyward fungicide film. The three ply A/B/C film was made by coextruding the middle layer A (A composed of 57% HMW-HDPE, OCTENE VLLDPE and 18% white concentrate), Earthward layer B (B composed of 73.4% 20MFI LLDPE BUTENE, 18% white concentrate, 5.6% fungicide earthward concentrate and 3% slip/antiblock concentrate) and Skyward layer C(C composed of 74.8% 20MFI LLDPE BUTENE, 17% UV Black concentrate, 5.20% fungicide skyward concentrate and 3% slip/antiblock concentrate). The coextruded film is about 1.25 mil thickness comprised of 0.75 mil middle layer A, 0.25 mil earthward layer B and 0.25 mil skyward layer C. The throughput of extruders A, B and C were maintained around 369.5, 122.0 and 114.7 lbs/hr respectively. Furthermore, the size of said extruders A, B and C were 80 mm, 70 mm and 70 mm diameter respectively with L/D 26:1. The film was produced at 34.72″ wide using 10″ circular die and a total film density of 1.012 g/cm3. The flow of material is constantly controlled and adjusted in such a way, that the final amount of fungicide in the earthward layer and skyward layer of final plastic article is around 0.6% and 0.2% by weight respectively.

### Field Studies

This trial was initiated in a research field to determine the efficacy of fungicide impregnated plastic mulch for the control of Phytophthora capsici of yellow summer squash. The trial site has a history of a natural infestation of P. capsici which is virulent on the yellow squash common to the region. Raised beds were formed using typical commercial farm equipment and were equipped with a center drip line for irrigation and application of typical pesticide crop protection products through the drip line. Yellow summer squash seedlings were transplanted 24 days after film installation. Experimental mulch were compared to standard low density polyethylene mulch (LDPE) with seven subsequent biweekly treatments of standard fungicide drenches after transplanting

Table V shows Yellow summer squash plant mortality to P. capsici and total yield.

TABLE V

| | Days after application | | | | | |
|---|---|---|---|---|---|---|
| | 0 day | 40 days | | 70 days | | |
| | Fluopicolide and | Fluopicolide | | Fluopicolide | | |
| | Fenamidone | and | Plant death | and | Plant death | 90 days |
| | concentration in film | Fenamidone | caused by P. | Fenamidone | caused by P. | Yield |
| | [g/ha] | in film [g/ha] | capsici (%)z | in film [g/ha] | capsici (%)z | [kg/plot]y |
| Standard mulch | 0 | 0 | 6.3 | 0 | 53.1 | 18 |
| PRESIDIO 4SC per drench application = 140 | | | | | | |
| g/ha Fluopicolide together with | | | | | | |
| REASON 500 SC per drench = 183 g/ha | | | | | | |
| Fenamidoneapplication under Standard Mulch | n/a | n/a | 0 | n/a | 6.3 | 30 |
| Experiemental Film with incorporated 120 g/ha | | | | | | |
| incorporated Ffluopicolide and 250 g/ha | | | | | | |
| incorporated Fenamidone | 120 & 250 | 10 & 13 | 1.6 | 0/0 | 9.4 | 28 |

zPercentage of plants per replicated killed by P. capsici, 16 total squash plants per replicate.
yTotal yield from 3 weeks of harvest of all surviving plants.
Benton Harbor, MI: Soil type: sandy loam

Presidio® is a selective fungicide EPA Reg. No. 59639-140 for control and/or suppression of diseases and fungi marketed by Valent Corporation USA. Presidio® is a formulation of contains 39.5% by weight Fluopicolide as active ingredient and 60.5% other ingredients. The maximum dose allowed for the use in yellow summer squash is 0.5 lbs/acre of the active ingredient Fluopicolide). According to the label the required days between last application and harvest for yellow summer squash is 2 days.

Reason® is a selective fungicide EPA Reg. No. 264-695 for the control of fungal diseases marketed by BayerCropScience Reason® is a formulation of contains 44.4% by weight Fenamidone as active ingredient and 55.6% other ingredients. The maximum dose allowed for the use in yellow summer squash is 0.71 lbs/acre of the active ingredient Fenamidone. According to the label the required days between last application and harvest for yellow summer squash is 2 days.

The time interval from transplanting to harvest mature yellow summer squash is typically in the range of 65 days. Fluopicolide and Fenamidone in the film are detected indirectly by HPLC with Mass spectroscopy combination from water/acetonitrile extract of 100 cm² film sample. Limit of quantification (LOQ) is 50 ng/l.

### Example 4

### Preparation of Skyward Fungicide Concentrate

5 Kg skyward fungicide concentrate is prepared by weighing Fluopicolide fungicide chemical and poly (ethylene oxide) polymer at 2.47 and 97.53 weight percent respectively. Each component is fed to the mixing vessel through a separate port. Furthermore, each component has a separate weighing system. Both components are initially mixed together as a cold mix for a period of three minutes followed by heating the vessel for 20 minutes at reduced rpm throughout the transition state from solid to molten phase. Temperature of vessel afterward is reduced with adequate increase in mixing speed for five minutes. The discharge port of the mixing vessel is turned to an open position to discharge molten polymer into small/medium chunk sizes. A metal sheet is used to cool down chunks by conduction means for five to 10 minutes accordingly. A pulverizing unit is used afterward to down size the chunks to the desired geometry.

### Example 5

### Preparation of Earthward Herbicide Concentrate

5 Kg earthward herbicide concentrate is prepared by weighing Halosulfuron-methyl herbicide chemical and poly (ethylene oxide) polymer at 0.547 and 99.453 weight percent respectively. Each component is fed to the mixing vessel through a separate port. Furthermore, each component has a separate weighing system. Both components are initially mixed together as a cold mix for a period of three minutes followed by heating the vessel for 20 minutes at reduced rpm throughout the transition state from solid to molten phase. Temperature of vessel afterward is reduced with adequate increase in mixing speed for five minutes. The discharge port of the mixing vessel is turned to an open position to discharge molten polymer into small/medium chunk sizes. A metal sheet is used to cool down chunks by conduction means for five to 10 minutes accordingly. A pulverizing unit is used afterward to down size the chunks to the desired geometry.

Manufacturing of a Three-Layered Film with an Earthward Herbicide Releasing Layer and Skyward Fungicide Releasing Layer

A three-layer coex blown film extrusion line was used according to the present disclosure to produce an earthward herbicide film and skyward fungicide film. The three ply A/B/C film was made by coextruding the middle layer A (A composed of 54% LLDPE OCTENE, 37% LLDPE Butene, 8% Black concentrate and 1% UV concentrate), earthward layer B (B composed of 95% 2MFI LDPE and 5% herbicide earthward concentrate) and skyward layer C(C composed of 83.9% 2MFI LDPE, 8% Black concentrate, 5.1% fungicide skyward concentrate, 1% UV concentrate and 2% slip/antiblock concentrate). The coextruded film is about 2.00 mil thickness comprised of 1.00 mil middle layer A, 0.60 mil earthward layer B and 0.40 mil skyward layer C. The throughput of extruders A, B and C were maintained around 223.1, 131.6 and 90.0 lbs/hr respectively. Furthermore, the size of said extruders A, B and C were 80 mm, 70 mm and 70 mm diameter respectively with L/D 30:1. The film was produced at 42.07″ wide using 16″ circular die and a total film density of 0.936 g/cm³. The flow of material is constantly controlled and adjusted in such away, that the final amount of herbicide in the earthward layer and fungicide in the skyward layer of final plastic article is around 0.03% and 0.13% by weight respectively.

### Applications of Multilayer Film Releasing Active Ingredients for Protection of Perishable Goods

As briefly expressed hereinabove, a multilayer film capable of releasing active ingredients may be used in producing a bag for the protection of perishable goods. Unless otherwise specified hereinbelow, the methods of manufacture, compounds, and most numerical values related to compound percentages, molecular weights, temperatures presented hereinabove are applicable to the production of such multilayer film bags. Of course, those of ordinary skill in the art will appreciate that many of the pesticides mentioned hereinabove, including herbicides, fungicides, insecticides and nematicides intended for destroying or controlling any pest, including vectors of human or animal disease, unwanted species of plants or animals, may be unsuitable for applications related to the preservation of eatable perishable goods. A non-limiting list of active ingredients that may be incorporated in a multilayer film bag intended for the preservation of eatable perishable goods include antimicrobials such as benzoates (for example sodium benzoate, benzoic acid), nitrites (for example sodium nitrite), and sorbates (for example sodium sorbate, potassium sorbate) which prevent microbial growth by inhibitory effects. Other possible active ingredients intended for the preservation of eatable perishable goods include antioxidants such as sulfites (for example as sodium sulfite), vitamins (such as E and C), butylated hydroxytoluene (BHT), butylated hydroxyanisole (BHA) and Polyphosphates that prevent undesirable chemical changes by oxidation. Theses antimicrobials and antioxidants may not be suitable for destroying or controlling any pest, including vectors of human or animal disease, unwanted species of plants or animals in agricultural production.

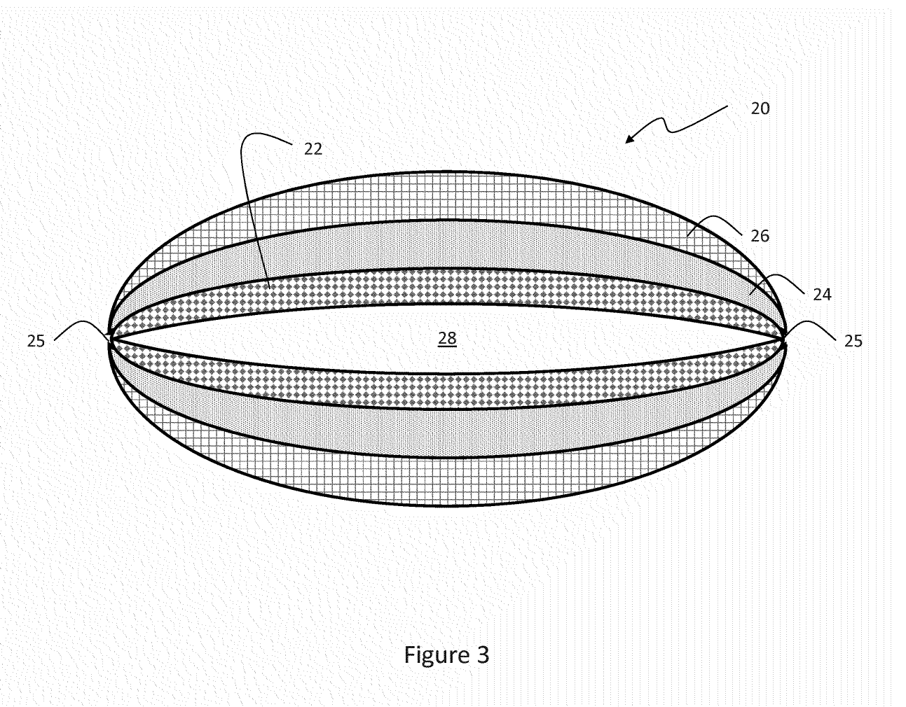

FIG. 3 is a schematic cross-section view of a multilayer film bag according to yet another embodiment. As shown on FIG. 3, an illustrative embodiment of the present disclosure includes a multilayer film bag 20 including an internal layer 22, an external layer 26, and an optional middle layer 24. A multilayer film, similar to the film 10 of FIG. 1, is wrapped around and attached on both sides at seams 25 as well as at one end (not shown) to form the bag 20. Goods, for example food items and other perishable goods may be placed within an interior 28 of the bag 20. FIG. 3 is not to scale and thicknesses of the layers 22, 24 and 26 are greatly exaggerated for illustration purposes. Each layer 12, 14, 16 may have a distinct thickness.

Comparing FIGS. 1 and 3, the lower, earthward layer 12 of the multilayer film 10 has become the internal layer 22 of the multilayer film bag 20 while the upper, skyward layer 16 of the multilayer film 10 has become the external layer 26 of the multilayer film bag 20. Finishing of the multilayer film bag 20 at the seams 25 and at an un-shown seam at one end may be made using any known technique for producing ordinary bags. The multilayer film bag 20 may be fabricated of a tubular multilayer film by simply cutting the tubular multilayer film and forming a seam at one end. In a variant, the multilayer film bag 20 may be fabricated by folding a multilayer film and forming one seam 25 on one side, the other side forming a continuous multilayer film. Of course, seams 25 may be present on both sides of the multilayer film bag 20.

Though not illustrated, the multilayer film bag 20 may be manufactured using a multilayer film having sub layers in its middle layer, as shown on FIG. 2.

In an embodiment, the internal layer 22 of the multilayer film bag 20 has, an internal layer comprises 92 to 98.99% by weight of water-insoluble polyethylene homo- and copolymers, about 1 to 5% by weight of a water-soluble polymer, and 0.01 to 3% by weight of at least one active ingredient. If present, the middle layer 24 is free from any active ingredient. The middle layer 24 may comprise at least one middle layer of polymeric film that in turn comprises one of i) a low density polyethylene (LDPE) with a high density polyethylene (HDPE) and optionally a surfactant suitable to migrate to the outer surface of the active ingredient-free middle layer, ii) a polyamide resin, or iii) an ethylene vinyl alcohol copolymer. The middle layer 24 may further comprise a plurality of polymeric film sub layers to prevent delaminating of the multilayer film bag. In one or more variants, at least one middle layer is sandwiched between small layers comprising cyclic anhydride modified polyolefin resins.

In yet another variant the external layer 26 may also comprise one or more active ingredients. For some applications, active ingredients may remain permanently within the external layer 26. For some other applications, the external layer 26 may be designed to release its active ingredients over time. In the latter case, the external layer 26 comprises 92 to 98.99% by weight of water-insoluble polyethylene homo- and copolymers, about 1 to 5% by weight of a water-soluble polymer, and 0.01 to 3% by weight of at least one active ingredient.

Whether an active ingredient is present solely in the internal layer 22 or both in the internal layer 22 and in the external layer 26, the water-soluble polymer of these layers may comprise polyvinyl alcohol, polyvinylpyrrolidone, polysorbate, poly (ethylene oxide) or a combination thereof. In a particular aspect, the polysorbate may be derived from polyethoxylated sorbitan esterified with fatty acids.

The water-soluble polymer of the internal layer 22 may comprise poly (ethylene oxide) having a molecular weight ranging from about 100,000 to about 8,000,000. The water-soluble polymer may further comprise one or more plasticizers including glycerol, polyethylene glycol, sorbitol or a combination thereof. Either of the internal or external layers may comprise one or more additives, for example colorants, UV absorbents, inhibitors, light stabilizers, anti-blocks, slip agents, lubricants, anti-oxidants, anti-fog additives or a combination thereof.

The active ingredient present in the internal layer 22 may comprise a food preservative, sodium benzoate, ascorbic acid (Vitamin C), sodium chloride (NaCl), calcium propanoate, butylated hydroxy toluene, tocopherols, potassium sorbate, biocides, nisin, lysozyme, a compatible pesticide, a fungicide, a germicide, zinc oxide (ZnO) or another antimicrobial, an oxygen scavenger, a carbon dioxide scavenger, an ultraviolet absorber or a combination thereof.

Various polymers, active ingredients and other compounds mentioned in the present disclosure need to be used with caution when the multilayer film bag 20 is used for protection of food items. Some compounds may be subject to various government specifications related to safe use of pesticides, food preservatives or other chemical products. For example, the Food and Drug Administration (FDA) and the Environmental Protection Agency (EPA) of the United States define limitations to human or animal exposure to various compounds mentioned herein. Specifications may differ between various jurisdictions and may change over time. The skilled reader of the present disclosure should ensure proper compliance to all relevant regulations when manufacturing or using multilayer film bags as disclosed herein.

The multilayer film bag 20 may be manufactured using a blow extrusion method. The method is initiated when 60 to 99% by weight of at least one water-soluble polymer is first premixed with at least one active ingredient. The premix is generated from a range of 1 to 40% by weight of the at least one active ingredient in a melt set at appropriate temperature in a hot jacketed mixer with variable mixing speeds. The premix is then cooled and the resulting premix is pulverized. An admixture in 1 to 10% by weight of the premix is added to a water-insoluble polymer. The multilayer film is then generated by blow extrusion. In at least one variant, the water-insoluble polymer may comprise polyethylene homo- and co-polymers. In any case, a plastic article may be formed from the film.

In another aspect, the present disclosure introduces an active ingredient composition for incorporation in the multilayer film bag 20. The active ingredient composition comprises at least one food preservative. The composition also comprises at least one water-soluble polymeric material as a carrier resin, and may further comprise a supplemental water-insoluble polymeric material as a carrier resin. In some variants, the supplemental water-insoluble polymeric material as a carrier resin may be omitted. The at least one water-soluble polymeric material is selected to be incompatible with the polyolefin materials of the multilayer film bag 20 described hereinabove. The at least one water-soluble polymeric material may for example comprise polyvinyl alcohol, polyvinylpyrrolidone, polysorbate, poly (ethylene oxide), non-ionic polymers, water-soluble polymers which can cross-link to form gels or a combination thereof. In contrast, the supplemental water-insoluble polymeric carrier resin is selected to be compatible with the polyolefin materials of the multilayer film bag 20 described hereinabove. The supplemental water-insoluble polymeric carrier resin may for example comprise homopolymers, copolymers, waxes, biocompatible polymers, derivatives or a combination thereof. The composition may be a pulverized to obtain a flaky polymeric form suitable for the above described a blow extrusion method of manufacturing the multilayer film bag 20.

The active ingredient composition for incorporation in the multilayer film bag 20 may be prepared by adding at least one food preservative, at least one water-soluble polymeric material, none or at least one water-insoluble polymeric material and optionally one or more additive(s) in a mixing vessel or a tank. A premix is then prepared by cold mixing the food preservative, the water-soluble polymeric material, the water-insoluble polymeric material (if present) and the additives (if present) under low shear conditions for adequate time. The mixing vessel is heated appropriately to create the correct conditions to prepare an active ingredient concentrate mix. Proper thermal distribution and adequate dispersion of viscous mix are provided by alternating mixing speed and duration of mixing. Reducing the premix temperature is followed by a discharge of the molten premix and its transfer to a dry cooling unit. The molten premix is finally cooled in the dry cooling unit by convection, conduction or a combination of both techniques.

In a non-limiting embodiment, a total thickness of the multilayer film bag 20, including the internal layer 22, the external layer 26, and the middle layer 24 if present, may range from 0.5 mil to 10 mil. A range of 1 mil to 5 mil will be suitable for a wide range of applications. The internal layer 22 may form 10%-30%, for example 15%-25%, of that total film thickness.

When a food item, for example meat, fruits, vegetables, cheese, cereal, bread, and the like, is placed in the multilayer film bag 20, the food item generally releases at least a modest amount of humidity. Water vapor released from the food item alters the water-soluble polymer of the internal layer 22, thereby releasing the active ingredient present in the internal layer 22. For very dry products, such as nuts, a modest amount of humidity may be added to the food item when placed in the multilayer film bag 20. The nature and amount of the active ingredient are selected according to the intended use, for example based on the type of food item, on a known or expected level of humidity of the food item, on a known or expected temperature during the life of the packaged food item, on an expected shelf life of the product, and on the type of bacteria, fungi, virus or other pest that is expected to be present in the environment of the food item. These criteria also impact the nature and amount of the water-soluble polymer in order to impact the rate and duration of release of the active ingredient within the multilayer film bag 20.

The shelf life of most consumable products may vary between 5 days to 3 months. Table VI provides a few, non-limiting examples of expected shelf lives for various food products.

TABLE VI

| Food Product Type | Expected Shelf Life | |
|---|---|---|
| Sliced cheese | 1 | month |
| Semi hard cheese, shredded hard | 1-2 | months |
| cheese | | |
| Hard cheese | 2-4 | months |
| Vacuum beef, primal and sub-primal | 2-3 | months |
| Butter, opened container | 2-3 | weeks |
| Butter, closed container | 1-2 | months |
| Chicken | 6-12 | days |
| Bakery products | 3-5 | days |

Table VI is of course not inclusive of all possible uses of multilayer film bags 20. Such multilayer film bags capable of releasing active ingredients over a period of time may also be used for other applications, including for example preservation of seeds, potting soil, manure, flowers, chemical compounds, and the like. For uses that are not related to food preservation, active ingredients in multilayer film bags 20 may be extended to include a broad range of pesticides, herbicides, insecticides, that should be selected according to the intended use of the bags.

Those of ordinary skill in the art will realize that the description of the films and processes for making such films are illustrative only and are not intended to be in any way limiting. Other embodiments will readily suggest themselves to such persons with ordinary skill in the art having the benefit of the present disclosure. Furthermore, the disclosed films and processes may be customized to offer valuable solutions to existing needs and problems of controlled application of active ingredients including pesticides.

In the interest of clarity, not all of the routine features of the implementations of the present processes and film products are shown and described. It will, of course, be appreciated that in the development of any such actual implementation of the products and processes, numerous implementation-specific decisions may need to be made in order to achieve the developer's specific goals, such as compliance with application-, system-, regulatory- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of pesticides having the benefit of the present disclosure.

Although the present disclosure has been described hereinabove by way of non-restrictive, illustrative embodiments thereof, these embodiments may be modified at will within the scope of the appended claims without departing from the spirit and nature of the present disclosure.

1. A pesticide-releasing multilayer film comprising:
a) an outer (bottom) layer facing earthward, comprising:
92 to 98.99% by weight of water-insoluble polyethylene homo- and copolymers,
about 1 to 5% by weight of a water-soluble polymer, and
0.01 to 3% by weight of at least one pesticide;
b) a pesticide-free middle layer assembly comprising at least one middle layer; and
c) a further outer (top) layer facing skyward, comprising:
92 to 98.99% by weight of water-insoluble polyethylene homo- and copolymers,
about 1 to 5% by weight of a water-soluble polymer, and
0.01 to 3% by weight of at least one pesticide.

2. The pesticide-releasing multilayer film of claim 1, wherein the at least one pesticide from the outer top layer or the outer bottom layer is released over a limited period of time.

3. The pesticide-releasing multilayer film of claim 1, wherein the at least one pesticide from the outer top layer or the outer bottom layer is released earthward to the soil or skyward to maturing crops being on the film in advance of the pre-harvest interval.

4. The pesticide-releasing multilayer film of claim 1, wherein the water-soluble polymer of the a) outer layer facing earthward or of the b) outer layer facing skyward is selected from the group consisting of polyvinyl alcohol, polyvinylpyrrolidone, polysorbate, poly (ethylene oxide) and combinations thereof.

5. The pesticide-releasing multilayer film of claim 4, wherein the polysorbate is derived from polyethoxylated sorbitan esterified with fatty acids.

6. The pesticide-releasing multilayer film of claim 1, wherein the water-soluble polymer of the a) outer layer facing earthward or of the b) outer layer facing skyward is poly (ethylene oxide) having a molecular weight ranging from about 100,000 to about 8,000,000.

7. The pesticide-releasing multilayer film of claim 1, wherein the water-soluble polymer of the a) outer layer facing earthward or of the b) outer layer facing skyward further comprises one or more plasticizers selected from the group consisting of glycerol, polyethylene glycol, sorbitol and combinations thereof.

8. The pesticide-releasing multilayer film of claim 1, wherein the at least one pesticide is selected from the group consisting of insecticides, nematicides, fungicides, herbicides and combinations thereof.

9. The pesticide-releasing multilayer film of claim 1, wherein the water-insoluble polyethylene homo- and copolymers comprise a polymer selected from the group consisting of low density polyethylene (LDPE), high density polyethylene (HDPE), linear low density polyethylene (LLDPE), copolymers of ethylene and another hydrocarbon, and combinations thereof.

10. The pesticide-releasing multilayer film of claim 1, wherein the b) pesticide-free middle layer assembly comprises at least one middle layer of polymeric film, wherein said at least one middle layer comprises:
i) a low density polyethylene (LDPE), a high density polyethylene (HDPE), and optionally a surfactant suitable to migrate to the outer surface of the pesticide-free middle layer, or
ii) a polyamide resin, or
iii) an ethylene vinyl alcohol copolymer.

11. The pesticide-releasing multilayer film of claim 1, wherein the a) outer (bottom) layer or the c) outer (top) layer further comprise one or more additives.

12. The pesticide-releasing multilayer film of claim 11, wherein the one or more additives are selected from the group consisting of colorants, UV absorbents, inhibitors, Light stabilizers, anti-blocks, slip agents, lubricants, anti-oxidants, anti-fog additives and combinations thereof.

13. The pesticide-releasing multilayer film of claim 1, wherein the b) pesticide-free middle layer assembly comprises a plurality of polymeric film sub layers to prevent delaminating of the pesticide-releasing multilayer film, or of the plastic article comprising the pesticide-releasing multilayer film.

14. The pesticide-releasing multilayer film of claim 1, wherein the at least one middle layer is sandwiched between small layers comprising cyclic anhydride modified polyolefin resins.

15. A plastic article comprising the pesticide-releasing multilayer film of claim 1.

16. A blow extrusion method for manufacturing the pesticide releasing multilayer film of claim 1, comprising the steps of:
a) premixing 60 to 99% by weight of at least one water-soluble polymer with at least one pesticide, wherein 1 to 40% by weight of the at least one pesticide is in a melt set at appropriate temperature in a hot jacketed mixer with variable mixing speeds, thereby generating a premix;
b) cooling the premix;
c) pulverizing the resulting premix;
d) adding said premix as an admixture in 1 to 10% by weight to a water-insoluble polymer; and
e) generating the multilayer film by blow extrusion.

17. The method of claim 16, wherein the water-insoluble polymer of step d) is polyethylene homo- and co-polymers.

18. The method of claim 16, wherein the method further comprises the step of f) forming a plastic article from the film.

19. A pesticide-releasing multilayer film obtainable by the method of claim 16.

20. A plastic article obtainable by the method of claim 18.

21. A pesticide compound composition comprising:
a) at least one pesticide;
b) at least one water-soluble polymeric material as a carrier resin; and
c) none or at least one supplemental water-insoluble polymeric material as a carrier resin,
wherein the at least one water-soluble polymeric material is incompatible with the polyolefin materials of the pesticide-releasing multilayer film of claim 1, and is selected from the group consisting of polyvinyl alcohol, polyvinylpyrrolidone, polysorbate, poly (ethylene oxide), non-ionic polymers, water-soluble polymers which can cross-link to form gels and combinations thereof;
wherein the supplemental water-insoluble polymeric carrier resin is compatible with the polyolefin materials of the pesticide-releasing multilayer film of claim 1, and is selected from the group consisting of homopolymers, copolymers, waxes, biocompatible polymers, derivatives and combinations thereof.

22. The composition of claim 21, wherein the composition is in a pulverized flaky polymeric form suitable for the method step d) of claim 16.

23. A method of preparing the composition of claim 21 in a hot jacketed mixing unit, comprising the steps of:
a) adding at least one pesticide, at least one water-soluble polymeric material, none or at least one water-insoluble polymeric material and optionally one or more additive(s) in a mixing vessel or a tank;
b) preparing a premix by cold mixing the components of step a) under low shear conditions for adequate time;
c) heating the mixing vessel appropriately to create the correct conditions to prepare agro concentrate mix;
d) alternating mixing speed and duration of mixing to provide proper thermal distribution and adequate dispersion of viscous mix;
e) reducing the premix temperature;
f) discharging the molten premix;
g) transferring the discharged molten premix to a dry cooling unit;
h) cooling said molten premix in said dry cooling unit by convection, conduction or a combination of both techniques.

24. A pesticide composition obtainable by the method of claim 23.

25. A method for pest control in specialty crops comprising the steps of:
a) physically preparing a field and soil for planting of the crops;
b) placing the pesticide-releasing multilayer film of claim 1 on the prepared field, wherein the outer (bottom) surface faces earthward towards the soil to completely cover the surface of the field; and
c) puncturing the film after an induction period of 7 to 14 days at the spot where a seedling is intended to be planted so that a seedling can be inserted through the hole and planted in the soil.

26. Use of the pesticide-releasing multilayer film of claim 1 in specialty crop production.

27. Use of the plastic article of claim 15 in specialty crop production.

28. A multilayer film for releasing an active ingredient, comprising:
an outer layer composed in part of a water-soluble polymer fraction containing the active ingredient; and
a further outer layer.

29. The multilayer film of claim 28, wherein:
the outer layer comprises the water-soluble polymer fraction and a water-insoluble fraction; and
relative proportions of the water-soluble polymer fraction and of the water-insoluble fraction provide a pre-determined time of release of the active ingredient when the multilayer film is exposed to humidity.

30. The multilayer film of claim 28, comprising an active ingredient-free middle layer between the outer layer and the further outer layer.

31. The multilayer film of claim 28, wherein the further outer layer contains another active ingredient.

32. The multilayer film of claim 28, wherein the active ingredient contains a pesticide.

33. A multilayer film bag, comprising:
an internal layer, comprising:
92 to 98.99% by weight of water-insoluble polyethylene homo- and copolymers,
about 1 to 5% by weight of a water-soluble polymer, and
0.01 to 3% by weight of at least one active ingredient; and
an external layer.

34. The multilayer film bag of claim 33, comprising:
an active ingredient-free middle layer assembly comprising at least one middle layer.

35. The multilayer film bag of claim 34, wherein the active ingredient-free middle layer assembly comprises at least one middle layer of polymeric film, wherein said at least one middle layer comprises:
i) a low density polyethylene (LDPE), a high density polyethylene (HDPE), and optionally a surfactant suitable to migrate to the outer surface of the active ingredient-free middle layer, or
ii) a polyamide resin, or
iii) an ethylene vinyl alcohol copolymer.

36. The multilayer film bag of claim 34, wherein the active ingredient-free middle layer assembly comprises a plurality of polymeric film sub layers to prevent delaminating of the multilayer film bag.

37. The multilayer film bag of claim 34, wherein the at least one middle layer is sandwiched between small layers comprising cyclic anhydride modified polyolefin resins.

38. The multilayer film bag of claim 33, wherein the external layer comprises at least one active ingredient.

39. The multilayer film bag of claim 33, wherein the at least one active ingredient of the internal layer is released over a limited period of time.

40. The multilayer film bag of claim 33, wherein the water-soluble polymer of the internal layer is selected from the group consisting of polyvinyl alcohol, polyvinylpyrrolidone, polysorbate, poly (ethylene oxide) and combinations thereof.

41. The multilayer film bag of claim 40, wherein the polysorbate is derived from polyethoxylated sorbitan esterified with fatty acids.

42. The multilayer film bag of claim 33, wherein the water-soluble polymer of the internal layer is poly (ethylene oxide) having a molecular weight ranging from about 100,000 to about 8,000,000.

43. The multilayer film bag of claim 33, wherein the water-soluble polymer of the internal layer further comprises one or more plasticizers selected from the group consisting of glycerol, polyethylene glycol, sorbitol and combinations thereof.

44. The multilayer film bag of claim 33, wherein the internal layer or the external layer further comprise one or more additives.

45. The multilayer film bag of claim 44, wherein the one or more additives are selected from the group consisting of colorants, UV absorbents, inhibitors, light stabilizers, anti-blocks, slip agents, lubricants, anti-oxidants, anti-fog additives and combinations thereof.

46. The multilayer film bag of claim 33, wherein the at least one active ingredient comprises a food preservative.

47. The multilayer film bag of claim 33, wherein the at least one active ingredient is selected from sodium benzoate, ascorbic acid (Vitamin C), sodium chloride (NaCl), calcium propanoate, butylated hydroxy toluene, tocopherols, potassium sorbate, biocides, nisin, lysozyme, a compatible pesticide, a fungicide, a germicide, zinc oxide (ZnO), another antimicrobial, an oxygen scavenger, a carbon dioxide scavenger, an ultraviolet absorber, and combinations thereof.

48. A blow extrusion method for manufacturing the multilayer film bag of claim 33, comprising the steps of:
a) premixing 60 to 99% by weight of at least one water-soluble polymer with at least one active ingredient, wherein 1 to 40% by weight of the at least one active ingredient is in a melt set at appropriate temperature in a hot jacketed mixer with variable mixing speeds, thereby generating a premix;
b) cooling the premix;
c) pulverizing the resulting premix;
d) adding said premix as an admixture in 1 to 10% by weight to a water-insoluble polymer; and
e) generating the multilayer film by blow extrusion.

49. The method of claim 48, wherein the water-insoluble polymer of step d) is polyethylene homo- and co-polymers.

50. The method of claim 48, further comprising the step of f) forming a plastic article from the film.

51. A multilayer film bag obtainable by the method of claim 48.

52. An active ingredient composition comprising:
a) at least one food preservative;
b) at least one water-soluble polymeric material as a carrier resin; and
c) none or at least one supplemental water-insoluble polymeric material as a carrier resin,
wherein the at least one water-soluble polymeric material is incompatible with the polyolefin materials of the multilayer film bag of claim 33, and is selected from the group consisting of polyvinyl alcohol, polyvinylpyrrolidone, polysorbate, poly (ethylene oxide), non-ionic polymers, water-soluble polymers which can cross-link to form gels and combinations thereof;
wherein the supplemental water-insoluble polymeric carrier resin is compatible with the polyolefin materials of the multilayer film bag of claim 33, and is selected from the group consisting of homopolymers, copolymers, waxes, biocompatible polymers, derivatives and combinations thereof.

53. The composition of claim 52, wherein the composition is in a pulverized flaky polymeric form suitable for the method step d) of claim 48.

54. A method of preparing the composition of claim 52 in a hot jacketed mixing unit, comprising the steps of:
a) adding the at least one food preservative, at least one water-soluble polymeric material, none or at least one water-insoluble polymeric material and optionally one or more additive(s) in a mixing vessel or a tank;
b) preparing a premix by cold mixing the components of step a) under low shear conditions for adequate time;
c) heating the mixing vessel appropriately to create the correct conditions to prepare an active ingredient concentrate mix;
d) alternating mixing speed and duration of mixing to provide proper thermal distribution and adequate dispersion of viscous mix;
e) reducing the premix temperature;
f) discharging the molten premix;
g) transferring the discharged molten premix to a dry cooling unit;
h) cooling said molten premix in said dry cooling unit by convection, conduction or a combination of both techniques.

55. An active ingredient composition obtainable by the method of claim 54.

56. Use of the multilayer film bag of claim 33 for preserving a food item.
